(19) United States
(12) Patent Application Publication
(10) Pub. No.: US 2002/0112919 A1
(43) Pub. Date: Aug. 22, 2002

(54) Ladder tree stand

(76) Inventor: Thomas E. Graham JR., Wilmington, NC (US)

Correspondence Address: WILLIAM J. MASON, MACCORD MASON PLLC, POST OFFICE BOX 1489, WRIGHTSVILLE BEACH, NC, 28480, US

(21) Appl. No.: 09/747,884

(22) Filed: Dec. 22, 2000

(51) Int. Cl. E06C 7/16

(52) U.S. Cl. 182/116; 182/115

(57) ABSTRACT

A tree stand is described that enables the user to pivot a seat to multiple positions for improved visibility and shooting. The stand is constructed of a frame that includes a rear section with a seat mount, and a front section with a platform; a multi-section ladder having an upper end attachable to a lower part of the frame; a swivel seat; and a connector arm having a first end pivotally attached to the frame and a second end pivotally attached to the seat, whereby the seat can be pivoted to various seating positions relative to the frame. The stand also includes toothed tree engagement arms with stops to align hooks from a tree-girdling cinch longitudinally behind the teeth of the arms for improved clamping.

### BACKGROUND OF THE INVENTION

(1) Field of the Invention

The present invention relates generally to a tree stand for use by hunters, and in particular to a ladder tree stand that includes a seat that can be pivoted to different positions on the stand. Additionally, the invention provides for more secure means for attaching the stand to a tree.

(2) Description of the Prior Art

Tree stands used to provide an elevated seat for hunters are well known in the prior art. One type of stand, known as a climbing tree stand, is constructed of a seat section and a platform section. The sections are attached to a tree with the seat section being above the platform section. The hunter then raises the sections in an alternating fashion to elevate the stand to the desired height on the tree.

Another type of stand, known as a ladder tree stand, is generally comprised of hunter support section that is mounted on the upper end of a ladder. The hunter support section includes a horizontal platform, or footrest, and a seat spaced at a vertical level above and to the rear of the platform.

The ladder, which is usually comprised of multiple attachable sections for ease of transport, is commonly attachable at its upper end to the platform, with a framework being used to attach the platform and seat. In order to secure the tree stand to a tree trunk, a rear segment of the seat support is configured to engage a tree trunk. A chain or cable is attached at one end to the support section, and can be wrapped around the tree, with the other end being adjustably attachable to the support section to secure the tree stand to the tree.

When used, the tree stand is assembled and leaned against a tree, with the rear of the support section resting against the tree trunk. The hunter then climbs the ladder and secures the chain around the tree to hold the tree stand securely in position. The hunter is then able to sit on the seat with his feet on the platform, or stand on the platform, either facing away from or toward the tree.

Examples of ladder tree stands are described in the following patents:

| U.S. Pat. No. | Inventor(s) |
|---|---|
| 4,552,247 | Purdy |
| 4,579,198 | Lee |
| 4,742,888 | Amacker |
| 4,787,476 | Lee |
| 4,905,792 | Wilson |
| 5,016,732 | Dunn |
| 5,564,524 | Thaggard et al. |

A common problem with tree stands is the fact that the space provided for the hunter to sit is limited, restricting the hunter's ability to adjust his seating to different positions. Therefore, tree stands tend to be uncomfortable, especially during the prolonged periods during which they are used while waiting for deer or other game to approach within shooting range.

Even more importantly, the ability of the hunter to shift his position for greater visibility and to a more suitable shooting position when game is within range is limited. Thus, when seated, the hunter's position is restricted by the presence of the tree trunk immediately behind the hunter, and by the position of the seat relative to the platform. When the hunter is standing on the platform, the hunter's movement is restricted by the platform size, due in large part to the projection of the seat over the platform.

Deer or other game do not always stand to the front of the tree stand. Instead, game may be located to the side or rear of the stand, and may also move from one location to another. If the game is not directly in front of the tree stand, the hunter is forced to twist and turn to awkward positions, which make aiming difficult, and increase the risk that the hunter may fall off of the tree stand while attempting to get into shooting position. These problems are especially acute if hunting is with a bow and arrow.

Thus, there is a continuing need for a tree stand that will provide comfortable seating for a hunter during often long waiting periods, and which will enable the hunter to move to various positions for shooting not only to the front of the tree stand, but also the sides and rear of the stand. A stand with these advantages, which could be securely attached to a tree trunk, would be especially desirable.

### SUMMARY OF THE INVENTION

The present invention is directed to a tree stand that addresses these needs. In general, the tree stand herein described, like prior art ladder tree stands, is comprised of a platform or footrest, a seat, a ladder, and an attachment means to secure the tree stand to a tree trunk. However, the components of the invention, and their interrelationship, differ significantly from similar components in prior art tree stands, resulting in substantial improvements in seating comfort and the ability of the hunter to position himself at different locations on the stand, thereby increasing his ability to observe and shoot toward all areas around the tree upon which the stand is mounted.

More specifically, the tree stand of the present invention includes a frame with a platform mounted horizontally across the front section of the frame, and a seat support on the rear section of the frame. The frame also includes tree engagement arms to secure the stand to a tree. Ladder connectors are positioned on the lower surface of the frame for attaching a ladder.

The seat is moveable to various locations relative to the frame, and is comprised of a seat frame with an elongated connector arm having one end pivotally attached to the seat frame, and the opposite end pivotally attached to the frame's seat support section. With this construction, the connector arm can be rotated about the frame attachment point, and the seat can be swiveled about the attachment point to the connector arm, thereby permitting positioning of the seat at various locations relative to the frame and to any tree to which the stand is attached. The seat also includes a seating surface on the upper part of the frame, and may also include a seat back and arms.

Preferably, the frame is comprised of a rear frame section that includes the seat mount, and a front frame section that includes the platform. The rear and front frame section are secured to each other, e.g., by bolting abutting attachment bars. The rear frame section can be comprised of the front attachment bar, a pair of spaced side bars that extend rearwardly from the ends of the attachment bar, and a pair of rearwardly and outwardly extending tree engagement arms adapted to engage a tree trunk when the stand is attached to a tree.

The tree engagement arms can include front arm sections that are parallel to each other and extend rearwardly from the front attachment bar in a plane with the bars, and rear arm sections that extend outwardly from the rear ends of the front arm sections to engage the rear ends of the side bars, thereby forming an integral frame structure. In this configuration, the seat mount can be positioned centrally within the frame on the front bar sections. The seat mount is preferably comprised of a plate that is attached to the front arm sections, with the plate having a central bore for receiving a seat post. An upright tubular member for increased strength may surround the central bore.

The front frame section is preferably comprised of spaced parallel side bars, the aforesaid attachment bar, and connector bars that angle inwardly from the rear ends of the side bars to the outer ends of the attachment bar. The front frame section side bars are each preferably formed of a horizontal bar component, with a rear end attached to one of the connector bars, and a front end that is attached to the upper end of a vertical side bar component. The front frame side bars are preferably spaced apart at a greater distance than the spaced side bars of the rear frame section, resulting in a front frame section and platform that is wider than the rear frame section.

The platform is in the form of a rigid surface upon which the hunter can stand or rest his feet, and is preferably comprised of an outer framework with attached front, side and rear components, and a surface, such as a mesh grid that extends across the platform framework. A pair of spaced ladder attachment members extends downwardly from the lower surface of the frame, and preferably from the lower surface of the platform framework. One or more support bars can extend between the front frame attachment bar and the rear of the platform framework to assist in supporting the weight of the hunter.

The ladder may be a single piece ladder, but is preferably a multi-section ladder for ease in transporting the ladder to the desired location, as well as in shipping initially to the hunter. Thus, the ladder may be comprised of an upper ladder section, a lower ladder section, and preferably one or more intermediate ladder sections. Each ladder section is comprised of a pair of spaced parallel side rails, with a plurality of spaced rungs extending between the side rails.

The upper ends of the upper ladder section are adapted for attachment to the stand frame. For example, the stand frame can include a pair of spaced, downwardly extending tubular members, with the upper ends of the upper ladder section side rails being sized for insertion into the tubular members. The lower ends of the side rails of the upper and any intermediate section side rails can be tubular, with the upper ends of the intermediate and lower side rails being insertable into the side rails lower ends. The lower ends of the lower ladder section can include feet for positioning the ladder on the ground.

In order to attach the stand to a tree, the aforesaid tree engagement arms are positioned at an angle, e.g., from about 60° to 120° degrees relative to each other, and about 30° to about 60° relative to the longitudinal axis of the frame. Each arm includes an outer or front surface and an inner or rear surface. Spaced teeth extend from the rear surface of the arms, with the teeth preferably having longitudinal axes transverse to the longitudinal axes of the engagement arms.

The tree stand is secured to a tree with a flexible cinch that extends around the tree from one tree engagement arm to the other. The cinch may be e.g., a chain, a cable, a strap, or the like. A means is also provided for tightening the cinch around the tree to hold the stand securely against the tree, e.g., the cinch can be a heavy-duty nylon woven strap, with a turnbuckle being used to tighten the strap.

The cinch can include hooks at each end to fit over the engagement arms. The hooks may be positioned relative to a given tooth on each engagement arm by stops or pegs that extend from the outer surface of the engagement arms, i.e., on the opposite side of the engagement arm from the teeth.

Preferably, the pegs are transverse to the longitudinal axis of the engagement arm, and have longitudinal axes that are slightly closer to the outer end of their respective engagement arm than the longitudinal axis of the corresponding tooth. Thus, when a hook is secured to the engagement arm, the peg aligns the hook engagement point along the longitudinal axis of the tooth, so that the peg exerts a rearward force along the longitudinal axis of the corresponding tooth, resulting in a more secure attachment of the stand.

Accordingly, one aspect of the present invention is to provide a tree stand comprising a frame that includes a rear section with a seat mount, and a front section with a platform; a multi-section ladder having an upper end attachable to the frame; a swivel seat; and a connector arm having a first end pivotally attached to the frame and a second end pivotally attached to the seat, whereby the seat can be pivoted to various seating positions relative to the frame.

Another aspect of the present invention is to provide a tree stand comprising a frame, a ladder having an upper end attachable to the frame, and a seat supported by -the frame, the frame comprising first and second rearwardly and outwardly expanding tree engagement arms having rearwardly extending tree engaging teeth, and forward stops offset from the teeth; and a tree girdling cinch, the cinch including arm hooks at each end adapted for releasable attachment to the engagement arms, whereby each of the stops is positioned to hold the hooks longitudinally behind a selected tooth.

These and other aspects of the present invention will become apparent to those skilled in the art after a reading of the following description of the preferred embodiment.

### BRIEF DESCRIPTION OF THE DRAWINGS

FIG. 1 is a side view of the tree stand secured to a tree trunk.

FIG. 2 is a detailed side view of the upper portion of the tree stand with the seat attached.

FIG. 3 is a detailed front view of the upper portion of the tree stand with the seat attached.

FIG. 4 is a detailed top view of the upper portion of the tree stand without the seat attached.

FIG. 5 is a top view of the upper portion of the tree stand with the seat attached and oriented to a first position.

FIG. 6 is a top view of the upper portion of the tree stand with the seat attached and oriented to a second position.

FIG. 7 is a top view of the upper portion of the tree stand with the seat attached and oriented to a third position.

FIG. 8 is a detailed view of the seat bottom.

FIG. 9 is a detailed view of the tree clamping mechanism.

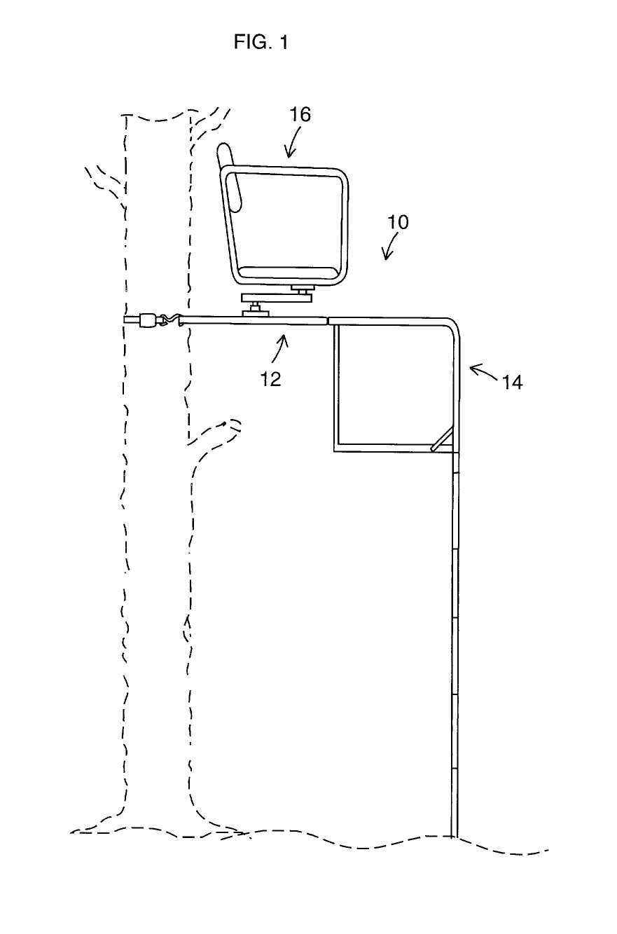

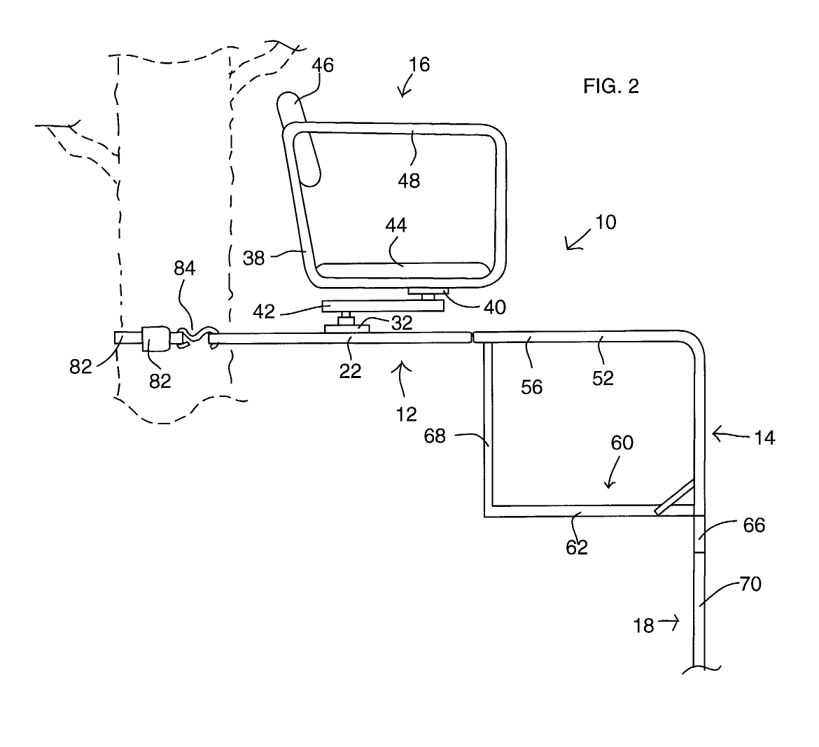

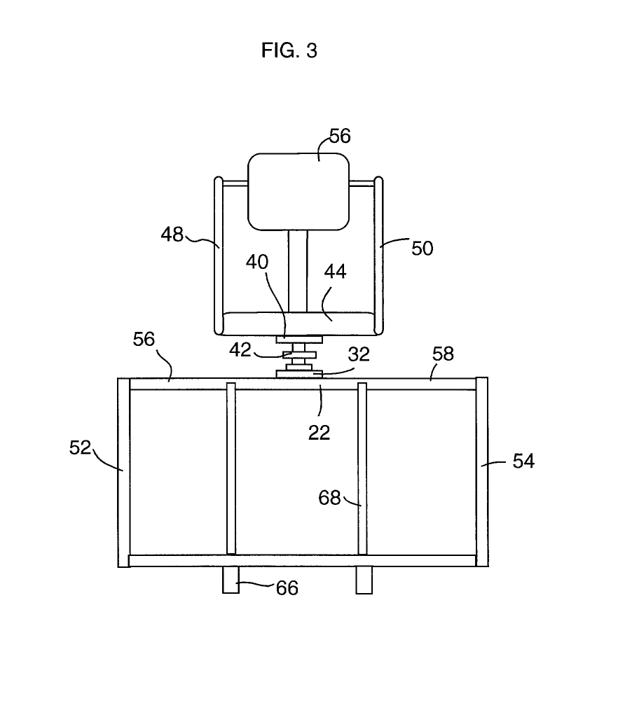

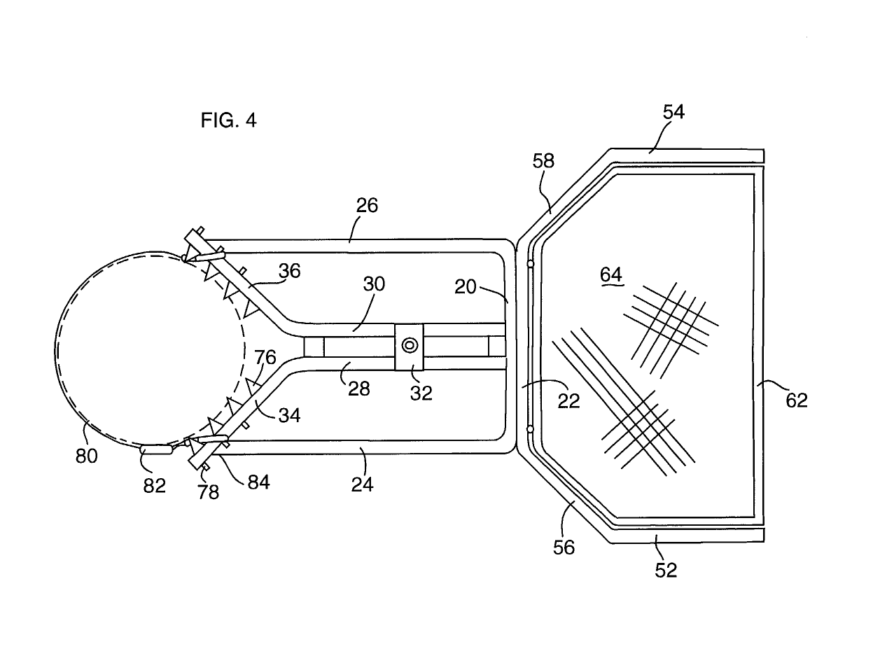

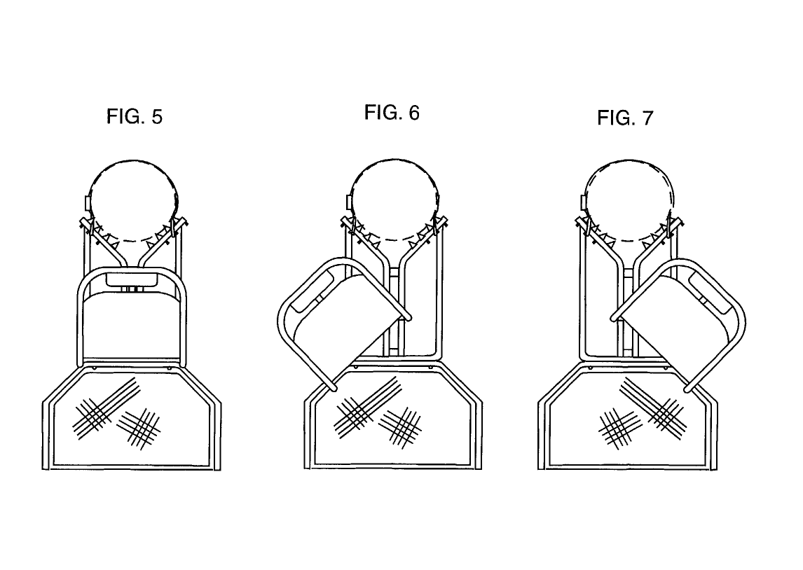

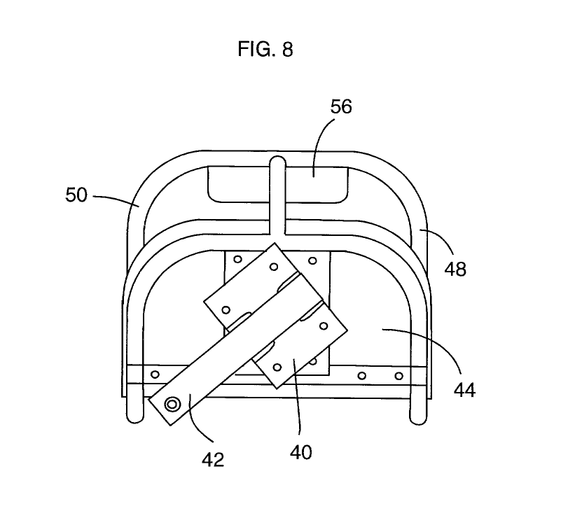

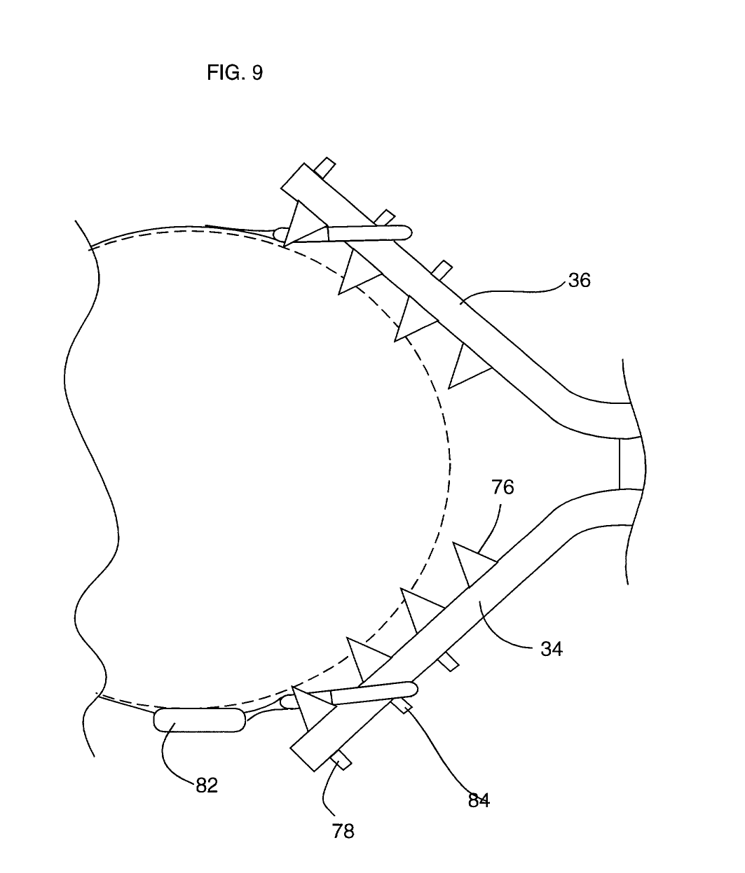

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

As illustrated in the drawings, tree stand, generally 10, is comprised of a rear frame section 12, a front frame section 14, a seat 16 supported on rear frame section 12, a platform secured to front frame section 14, and a ladder 18 attached beneath front frame section 14. Frame sections 12 and 14 include abutting attachment bars 20 and 22, respectively, that are bolted together when stand 10 is assembled.

Rear frame section 12, in addition to front attachment bar 20, is comprised of spaced side bars 24 and 26 extending rearwardly from the ends of attachment bar 20, and parallel center bars 28 and 30 that include seat mount 32, and terminate in rearwardly and outwardly extending tree engagement arms 34 and 36.

Seat 16 is comprised of seat frame 38 with a base plate 40. An elongated connector arm 42 has one end pivotally attached to the plate 40 and the opposite end pivotally attached to seat mount 32 carried on center bars 28 and 30, so that seat 32 can be positioned at various locations. Seat 32 also includes a seating surface 44, a seat back 46, and arms 48 and 50. Tree engagement arms 34 and 36 extend outwardly at an angle of about 90° relative to each other to engage the rear ends of the side bars 24 and 26.

Front frame section 14 is comprised of spaced parallel side bars 52 and 54 that are spaced apart at a greater distance that the spacing of rear side bars 24 and 26, aforesaid attachment bar 22, and connector bars 54 and 56 connecting bars 24 and 26, respectively to the opposed ends of attachment bar 22.

Platform 60 is comprised of an outer framework 62 and a horizontal metal grid 64 that extends across framework 62 to form a standing platform or footrest. A pair of spaced, tubular ladder attachment members 66 extend downwardly from the front lower surface of framework 62. Support bars 68 extend from attachment bar 22 to the rear of framework 62.

Ladder 18 is a multi-section ladder comprised of an upper ladder section 70, a lower ladder section 72, and preferably three intermediate ladder sections 74, each ladder section having spaced, tubular parallel side rails, with a plurality of spaced rungs extending between the rails. The upper ends of section 70 are insertable into attachment member 66, with the upper ends of sections 72 and 74 being insertable into the lower ends of the above section.

Each engagement arm 34 or 36 includes spaced, rearwardly extending teeth 76 with longitudinal axes that are transverse to the longitudinal axes of the arm upon which they are mounted, and stops or pegs 78 extending forward from opposite side of engagement arms 34 and 36. Pegs 78 are also aligned transverse to the longitudinal axis of the engagement arm on which they are carried. Each peg 78 is associated with a tooth 76, with the longitudinal axes of each tooth and peg pair being parallel. The longitudinal axis of each peg is slightly closer to the outer or distal end of the arm carrying the peg, than is the longitudinal axis of the tooth of the pair.

Tree stand 10 is secured to a tree with flexible cinch 80, which can be a woven nylon belt, that extends around the tree from arm 34 to 36. Cinch 80 includes a turnbuckle 82 for use in tightening or loosening cinch 80. A hook 84 is attached to each end of cinch 80, with each hook 84 being sized for hooking over an attachment arm behind one of pegs 78. When hook 84 is secured to the engagement arm, the peg 78 against which hook 84 is held, aligns hook along the longitudinal axis of a tooth 76.

When tree stand 10 is used, the hunter can move seat 16 to various positions by pivoting connector arm 42, and swiveling seat 16. Some of the possible positions are illustrated in FIGS. 5- 7. Due to these positions, the hunter is not only able to sit facing the front of the tree stand, but can also quickly and easily move the seat so that he is facing to the side or rear of the stand. Thus, the hunter is able to maintain a safe and comfortable shooting position when the game is approaching the stand from any position.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A tree stand comprising:
a) a frame;
b) a ladder having an upper end attachable to said frame;
c) a seat; and
d) a connector arm having a first end pivotally attached to said frame and a second end pivotally attached to said seat, whereby said seat can be pivoted to various seating positions relative to said frame.

2. The tree stand of claim 1, wherein said frame includes a platform.

3. The tree stand of claim 1, wherein said frame includes a rear section with a seat mount, and a front section with a platform.

4. The tree stand of claim 1, wherein said frame includes tree engagement arms.

5. The tree stand of claim 1, wherein said seat includes a frame, a seating section, a backrest, and a mounting plate attached to said frame beneath said seating section, said connector arm being pivotally attached to said mounting plate.

6. The tree stand of claim 1, wherein said ladder is a multi-section ladder comprised of an upper section, a lower section, and at least one intermediate section.

7. A tree stand comprising:
a) a frame includes a rear section with a seat mount, and a front section with a platform;
b) a multi-section ladder having an upper end attachable to said frame;
c) a swivel seat; and
d) a connector arm having a first end pivotally attached to said frame and a second end pivotally attached to said seat, whereby said seat can be pivoted to various seating positions relative to said frame.

8. The tree stand of claim 7, wherein said rear and front frame sections are releasibly attachable.

9. The tree stand of claim 7, wherein said rear frame section is comprised of spaced side bars having front and rear ends, a front attachment bar attachable to said front frame section and extending between the front ends of said side bars, a pair of rearwardly and outwardly expanding tree engagement bars, and a seat mount.

10. The tree stand of claim 7, wherein said front frame section is comprised of spaced side bars, a platform extending between said side bars, and a rear attachment bar attachable to said rear frame section.

11. The tree stand of claim 7, wherein said platform is wider than said ladder.

12. The tree stand of claim 7, wherein said seat includes a seating section, said connector arm being pivotally attached beneath said seating section.

13. The tree stand of claim 7, further including an adjustable cinch with ends attachable to said tree engagement arms.

14. The tree stand of claim 7, wherein said tree engagement arms includes rearwardly projecting teeth, and forward projection retainer stops.

15. A tree stand comprising a frame with a tree attachment section, said tree attachment section comprising:
a) first and second rearwardly and outwardly expanding tree engagement arms having rearwardly extending tree engaging teeth, and forward stops offset from said teeth; and
b) a tree girdling cinch, said cinch including arm hooks at each end adapted for releasable attachment to said engagement arms, whereby each of said stops is positioned to hold said hooks longitudinally behind a selected tooth.

16. The tree stand of claim 15, wherein said teeth are positioned transverse to said engagement arms.

17. The tree stand of claim 15, wherein said engagement arms have distal ends and each stop is associated with a given tooth, each peg being closer to said engagement arm distal end than said given tooth.

18. The tree stand of claim 15, wherein said cinch is a woven belt with an adjustable turnbuckle.

19. The tree stand of claim 15, wherein said engagement arm expand outwardly from each other at an angle of from about 60 ° to about 120°.

20. The tree stand of claim 15, wherein said frame is comprised of separable rear and front sections, said engagement arms extending rearwardly from said rear frame section.
